(19) United States
(12) Patent Application Publication
(10) Pub. No.: US 2025/0271655 A1
(43) Pub. Date: Aug. 28, 2025

(54) OBSERVATION APPARATUS

(71) Applicant: Keyence Corporation, Osaka (JP)

(72) Inventors: Ryosuke KONDO, Osaka (JP); Kenichiro HIROSE, Osaka (JP)

(73) Assignee: Keyence Corporation, Osaka (JP)

(21) Appl. No.: 19/033,538

(22) Filed: Jan. 22, 2025

(30) Foreign Application Priority Data
Feb. 28, 2024 (JP) 2024-027965

(51) Int. Cl. G02B 21/36

(52) U.S. Cl. CPC G02B 21/361; G02B 21/362; G02B 21/365

(57) ABSTRACT

Provided is a highly convenient observation apparatus. An observation apparatus includes an observation unit that generates an observation image of an observation target, an analysis unit that analyzes the observation target, and an information processing unit that communicates with the observation unit and the analysis unit. The analysis unit includes an analysis beam device that emits an analysis beam to the observation target. The information processing unit includes a cluster region specification unit, a sequence determination unit, and an analysis execution unit. The cluster region specification unit specifies a plurality of cluster regions included in the observation image. The sequence determination unit determines a sequence of analyzing the cluster regions. The analysis execution unit causes the analysis beam device of the analysis unit to sequentially irradiate the cluster regions with the analysis beam according to the analysis sequence determined by the sequence determination unit.

### CROSS-REFERENCE TO RELATED APPLICATIONS

The present application claims foreign priority based on Japanese Patent Application No. 2024-027965, filed Feb. 28, 2024, the contents of which are incorporated herein by reference.

### BACKGROUND OF THE INVENTION

### 1. Technical Field

The invention relates to an observation apparatus.

### 2. Description of the Related Art

For observation and analysis of an observation target, an observation apparatus such as a microscope may be used.

The microscope disclosed in JP2022-064854A includes an observation optical system including a camera that captures an observation target, an analysis optical system including an electromagnetic wave emission unit that emits electromagnetic waves for analyzing the observation target, and a horizontal drive mechanism that moves the observation optical system and the analysis optical system.

In the observation apparatus of JP2022-064854A, after a portion to be observed is captured by the camera, the captured portion to be observed is irradiated with the electromagnetic waves, and thus, the portion to be observed can also be analyzed. However, it is difficult to collectively and sequentially analyze a plurality of analysis portions, and there is a problem in convenience.

### SUMMARY OF THE INVENTION

In view of the above problems, an object of the invention is to provide a highly convenient observation apparatus.

In order to solve the above problems, an observation apparatus as an example of an embodiment according to the invention is an observation apparatus that includes a mounting table on which the observation target is mounted, an observation unit that generates an observation image of the observation target, an analysis unit that analyzes the observation target, and an information processing unit that communicates with the observation unit and the analysis unit. The observation unit includes an observation objective lens that receives light from the observation target, and an observation camera that generates the observation image by capturing the observation target through the observation objective lens, the analysis unit includes an analysis beam device that emits an analysis beam to the observation target, and a detector that detects energy absorbed by the observation target or energy released from the observation target by irradiation of the analysis beam, and the information processing unit includes a capturing control unit that generates the observation image by controlling the observation camera of the observation unit to capture the observation target, a cluster region specification unit that specifies a plurality of cluster regions included in the observation image, a sequence determination unit that determines an analysis sequence of analyzing the cluster regions, and an analysis execution unit that causes the analysis beam device of the analysis unit to sequentially irradiate the cluster regions with the analysis beam according to the analysis sequence determined by the sequence determination unit, and causes the analysis unit to execute analysis of the cluster region based on a detection result of the detector.

According to the invention, since the analysis sequence of analyzing the plurality of cluster regions included in the observation target is determined and the cluster regions are sequentially irradiated with the analysis beam according to the analysis sequence, it is not necessary to repeat the capturing of the observation image by the observation unit for each cluster region as the analysis target, and the convenience of the observation apparatus is enhanced.

### BRIEF DESCRIPTION OF THE DRAWINGS

FIG. 1 is a diagram schematically illustrating a configuration of an observation apparatus;

FIG. 2 is a diagram schematically illustrating a positional relationship among an observation unit, an analysis unit, and a mounting table of a capturing unit;

FIG. 3 is a diagram illustrating a state where a relative position of the analysis unit with respect to the mounting table is changed from FIG. 2;

FIG. 4 is a block diagram schematically illustrating a configuration of the capturing unit;

FIG. 5 is a block diagram schematically illustrating an information processing unit and a communication target of the information processing unit;

FIG. 6 is a block diagram schematically illustrating a configuration of the information processing unit;

FIG. 7 is a flowchart illustrating a flow of observation and analysis;

FIG. 8 is a diagram illustrating an example of a coupled image;

FIG. 9 is a diagram illustrating a relationship between an observation image and an analysis image;

FIG. 10 is a diagram illustrating a case where an irradiation point of an analysis beam is determined by using thinning processing;

FIG. 11 is a diagram illustrating a case where a geometric center of gravity of a cluster region is outside the cluster region;

FIG. 12 is a diagram illustrating a case where the cluster region is a fiber;

FIG. 13 is a diagram illustrating a case where a cluster region in an analysis image is deviated from a visual field center;

FIG. 14 is a diagram illustrating a case where a correction operation of a user is accepted;

FIG. 15 is a diagram illustrating an example of a result screen;

FIG. 16 is a diagram illustrating an example of the result screen in a case where spectrum analysis is performed; and

FIG. 17 is a diagram illustrating an example of an analysis list.

### DETAILED DESCRIPTION

Hereinafter, an observation apparatus 10 as an example of an embodiment according to the invention will be described with reference to the drawings. Note that, in the drawings, the same or corresponding portions are denoted by the same reference numerals, and the description thereof will not be repeated. In addition, in the following description, terms meaning positions or directions such as front, rear, left, right, upper, lower, and the like may be used, but these terms are used for the sake of convenience to facilitate understanding of the embodiment. These terms are not limited to front, rear, left, right, upper, lower, and the like in a geometrically strict sense unless expressly stated otherwise.

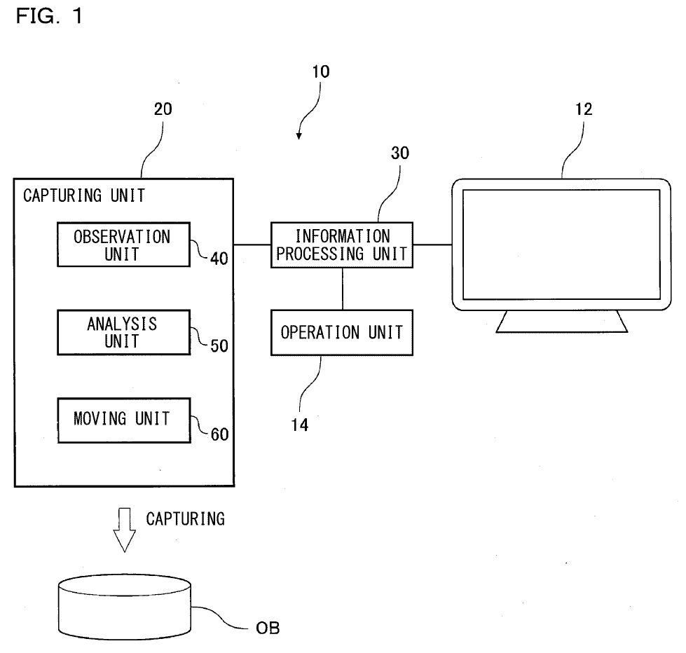

FIG. 1 is a diagram schematically illustrating a configuration of the observation apparatus 10. The observation apparatus 10 includes a display unit 12, an operation unit 14, a capturing unit 20, and an information processing unit 30. The information processing unit 30 communicates with the display unit 12, the operation unit 14, and the capturing unit 20. The information processing unit 30 is connected to the display unit 12, the operation unit 14, and the capturing unit 20 by, for example, a communication cable. For example, a cable that transmits and receives an electric signal, such as a universal serial bus (USB) cable, a local area network (LAN) cable, or a High-Definition Multimedia Interface (HDMI: registered trademark) cable, an optical cable that transmits and receives an optical signal, or the like is used as the communication cable. Note that, cables of different standards may be used in accordance with constituent elements to be connected. In addition, signals may be transmitted and received between the constituent elements by wireless communication using electromagnetic waves.

The information processing unit 30 is a unit including a processor such as a central processing unit (CPU) and a storage device such as a random access memory (RAM), and executes various types of information processing in the observation apparatus 10.

The display unit 12 is a unit including an image display device such as a liquid crystal display (LCD), and displays an image for a user of the observation apparatus 10. The operation unit 14 is a unit that accepts an operation of the observation apparatus 10 from the user. The operation unit 14 includes, for example, a user interface device such as a keyboard, a mouse, and a joystick. In addition, the operation unit 14 may include a controller exclusively designed for the observation apparatus 10.

The observation apparatus 10 is an apparatus that observes and analyzes an observation target OB. The capturing unit 20 is a unit that images and analyzes the observation target OB. The capturing unit 20 includes an observation unit 40, an analysis unit 50, and a moving unit 60. The information processing unit 30 communicates with the observation unit 40, the analysis unit 50, and the moving unit 60 of the capturing unit 20. The observation unit 40 is a unit that generates an observation image of the observation target OB. The analysis unit 50 is a unit that analyzes the observation target OB. The observation unit 40 and the analysis unit 50 may be an integrated unit or may be separate units. Note that, in a case where the observation unit 40 and the analysis unit 50 are separate units, the moving unit 60 changes relative positions of the observation unit 40 and the analysis unit 50 with respect to the observation target OB.

When the observation and analysis of the observation target OB are performed, first, the observation unit 40 captures the observation target OB to generate an observation image. Here, a display screen based on the observation image may be displayed on the display unit 12. The display screen may be generated by the information processing unit 30 based on the observation image.

After the observation image is generated by the observation unit 40, the observation target OB is analyzed by the analysis unit 50. Although details of the analysis will be described later, for example, component analysis of an analysis target is performed. Then, the information processing unit 30 generates a result screen indicating the analysis result, and the result screen is displayed on the display unit 12.

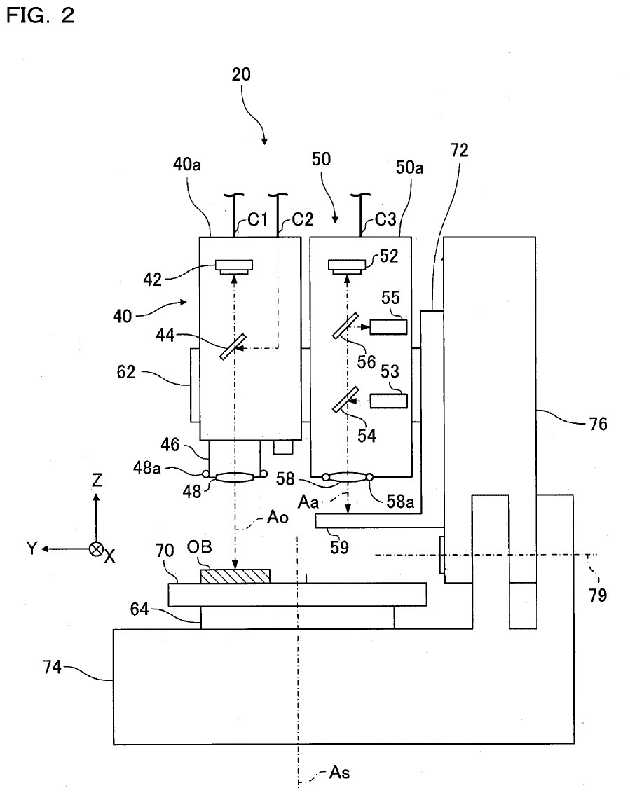

The capturing unit 20 will be described with reference to FIG. 2. FIG. 2 is a diagram schematically illustrating a positional relationship among the observation unit 40, the analysis unit 50, and a mounting table 70 of the capturing unit 20. The observation unit 40 is a unit covered with an observation housing 40a. The analysis unit 50 is a unit covered with an analysis housing 50a. The capturing unit 20 further includes the mounting table 70, a Z-direction stage 72, a support table 74, and a support column 76.

The mounting table 70 is a table on which the observation target OB is mounted. The mounting table 70 is supported by a mounting table control unit 64. The mounting table control unit 64 moves the mounting table 70 in a horizontal direction. In FIG. 2, a left-right direction in the drawing is the horizontal direction. The horizontal direction includes an X direction (left-right direction with respect to the entire capturing unit 20) and a Y direction (front-rear direction with respect to the entire capturing unit 20), but only the Y direction is illustrated in FIG. 2, and the X direction is a direction perpendicular to a paper surface. The mounting table control unit 64 moves the mounting table 70 in the X direction and the Y direction, and thus, the relative positions of the observation unit 40 and the analysis unit 50 with respect to the mounting table 70 and the observation target OB change. Note that, the mounting table control unit 64 is supported by the support table 74. The support table 74 supports the entire capturing unit 20.

The observation unit 40 is disposed above the mounting table 70. The observation unit 40 includes an observation camera 42 for capturing the observation target OB. The observation camera 42 is an element that converts reflected light or transmitted light from the observation target OB into an electric signal, and for example, an image sensor using a charge coupled device (CCD), an image sensor using a complementary metal oxide semiconductor (CMOS), or the like is used.

An observation communication cable C1 for communicating with the information processing unit 30 and a light guide cable C2 for guiding light from an outside are connected to the observation unit 40 in FIG. 2. The observation unit 40 includes the observation camera 42, an observation half mirror 44, a lens switching unit 46, an observation objective lens 48, and a side illumination 48a.

The observation half mirror 44 reflects the light guided by the light guide cable C2 and guides the light to a surface of the observation target OB through the observation objective lens 48. The light guided by the observation half mirror 44 is preferably coaxial with an observation optical axis Ao of the observation objective lens 48. When the external light guided by the light guide cable C2 and the observation half mirror 44 is coaxial with the observation optical axis Ao of the observation objective lens 48, the guided light functions as a coaxial illumination. Note that, although only one observation half mirror 44 is illustrated in FIG. 2, the light may be guided by a mirror group including a plurality of half mirrors. In addition, the mirror group may include a total reflection mirror. Note that, the observation unit 40 may include an observation light source that irradiates the observation target OB with light for observation. In a case where the observation light source is included in the observation unit 40, the light guide cable C2 is not necessarily required. In addition, the observation half mirror 44 transmits the light from the observation target OB received by the observation objective lens 48 and guides the light to the observation camera 42.

In addition, as illustrated in FIG. 2, the side illumination 48a is constituted by a ring illumination disposed so as to surround the observation objective lens 48. The side illumination 48a emits illumination light from obliquely above the observation target OB. Although not illustrated in detail, a central axis when the side illumination 48a is regarded as an annular ring coincides with the observation optical axis Ao. In addition, the side illumination 48a is divided into a plurality of blocks in a circumferential direction, and the blocks can be individually turned on.

The observation objective lens 48 has the observation optical axis Ao along a vertical direction (Z direction or an upper-lower direction in the drawing). The observation objective lens 48 receives (collects) the light from the observation target OB and guides an image of the observation target OB to the observation camera 42 along the observation optical axis Ao. Note that, additional various optical elements such as an imaging lens and an optical diaphragm may be disposed in an optical path between the observation objective lens 48 and the observation camera 42, and optical conditions such as a magnification and a focal length may be changeable. Note that, the observation optical axis Ao is preferably parallel to a reference axis As of the mounting table 70. The reference axis As is an axis perpendicular to an upper surface of the mounting table 70.

The observation objective lens 48 of FIG. 2 may be disposed below the observation unit 40 via the lens switching unit 46. The lens switching unit 46 includes a plurality of objective lenses having different magnifications, and one of the objective lenses is directed to the observation target OB, as the observation objective lens 48 for observing the observation target OB. The lens switching unit 46 is, for example, a revolver that switches the objective lens directed to the observation target OB by rotating. Even in a case where any objective lens is used as the observation objective lens 48, the lens switching unit 46 switches the objective lens such that the observation optical axis Ao coincides with an optical path through which the light is guided by the observation half mirror 44. Note that, the observation objective lens 48 is not limited to the configuration in which the objective lens is switched via the lens switching unit 46, and may have a configuration in which a zoom lens in which a magnification of the observation objective lens 48 is variable or an imaging lens used by being paired with the observation objective lens 48 is included in the observation housing 40a.

The observation unit 40 is attached to the Z-direction stage 72 via a unit moving unit 62. In addition, in addition to the observation unit 40, the analysis unit 50 is attached to the unit moving unit 62. In FIG. 2, the analysis unit 50 is disposed at a position closer to the Z-direction stage 72 than the observation unit 40. The unit moving unit 62 moves the observation unit 40 and the analysis unit 50 along the horizontal direction (Y direction in FIG. 2). The unit moving unit 62 is, for example, a unit including an arm that supports the observation unit 40 and the analysis unit 50 and an actuator (not illustrated) that moves the observation unit and the analysis unit along the arm in the horizontal direction. The unit moving unit 62 moves along the arm, and thus, the relative positions of the observation unit 40 and the analysis unit 50 with respect to the mounting table 70 change. Note that, the mounting table control unit 64 moves the mounting table 70 in the horizontal direction, and thus, the relative positions of the observation unit 40 and the analysis unit 50 with respect to the mounting table 70 may change.

Note that, the Z-direction stage 72 moves the observation unit 40 and the analysis unit 50 with respect to the mounting table 70 along the vertical direction (Z direction). In addition, the observation unit 40 and the analysis unit 50 can swing around a swing axis 79 extending in the Y direction through the support column 76. The Z-direction stage 72 is attached to the support column 76. Then, the support column 76 is connected to the support table 74 so as to be rotatable about the swing axis 79. The user of the observation apparatus 10 can swing the observation unit 40 and the analysis unit 50 around the swing axis 79. The user can observe the observation target OB not only from the vertical direction but also from an oblique direction by swinging the observation unit 40 and the analysis unit 50.

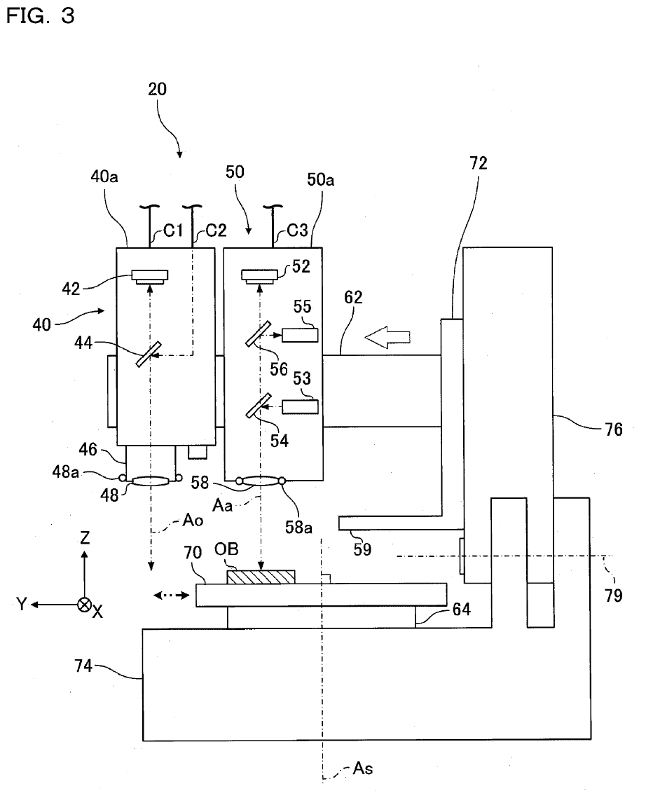

FIG. 3 illustrates a state where the relative position of the analysis unit 50 with respect to the mounting table 70 changes from that in FIG. 2. In FIG. 3, the unit moving unit 62 moves along the arm, and thus, the observation optical axis Ao of the observation unit 40 moves away from the observation target OB, and an analysis optical axis Aa of the analysis unit 50 moves toward the observation target OB. Therefore, in FIG. 3, the analysis unit 50 is disposed above the mounting table 70.

An analysis communication cable C3 for communicating with the information processing unit 30 is connected to the analysis unit 50 in FIGS. 2 and 3. The analysis unit 50 includes an analysis camera 52, an analysis beam device 53, an analysis half mirror 54, a detector 55, a detection half mirror 56, an analysis objective lens 58, and a side illumination 58a. The analysis camera 52 is a camera for capturing the observation target OB in a state where the analysis optical axis Aa of the analysis unit 50 is directed toward the observation target OB.

The analysis beam device 53 is a unit that emits an analysis beam to the observation target OB. As the analysis beam, different types of particle beams or waves are used depending on an analysis method. Examples of the analysis beam include infrared light, visible light, X-rays, laser, and electron beams. The analysis beam device 53 is, for example, a laser device or an electron gun.

The analysis half mirror 54 reflects the analysis beam emitted from the analysis beam device 53 and guides the analysis beam to the surface of the observation target OB through the analysis objective lens 58. The beam guided by the analysis half mirror 54 is preferably coaxial with the analysis optical axis Aa of the analysis objective lens 58. Note that, although only one analysis half mirror 54 is illustrated in FIG. 3, the analysis beam may be guided by a mirror group including a plurality of half mirrors. In addition, the mirror group may include a total reflection mirror. In addition, the analysis half mirror 54 transmits electromagnetic waves from the observation target OB received by the analysis objective lens 58 and guides the electromagnetic waves to the analysis camera 52 and the detection half mirror 56. Note that, depending on a type of the analysis beam (for example, in a case where the analysis beam is the electron beam), the analysis half mirror 54 may not be disposed, and the observation target OB may be directly irradiated with the analysis beam from the analysis beam device 53.

The detector 55 is a unit that detects reaction of the observation target OB with respect to the analysis beam (in particular, energy absorbed by the observation target OB or energy released from the observation target OB). The detector 55 is, for example, a Czerny-Turner spectrometer, a photomultiplier tube, or the like that detects light (electromagnetic waves), or an electron detector that detects electrons. The detector 55 receives the electromagnetic waves from the observation target OB via the analysis objective lens 58, the analysis half mirror 54, and the detection half mirror 56, and detects the reaction of the observation target OB based on the received electromagnetic waves. Note that, depending on the analysis method, the detector 55 may receive particles generated not from the electromagnetic waves but from the observation target OB. For example, the detector 55 is an electron detector such as a reflected electron or a secondary electron, and may receive electrons released from the observation target OB. In addition, the detector 55 may be a displacement meter that measures displacement generated in the observation target OB due to the reaction of the observation target OB or a refractive index meter that measures a change in a refractive index generated in the observation target OB. Depending on a type of the detector 55, the detector 55 may directly receive the electromagnetic waves or the particles generated from the observation target OB without using the analysis objective lens 58, the analysis half mirror 54, the detection half mirror 56, or the like. The detector 55 can detect the energy absorbed by the observation target OB or the energy released from the observation target OB based on the electromagnetic waves, the particles, or the like generated from the observation target OB.

The detection half mirror 56 reflects the electromagnetic waves received by the analysis objective lens 58 and guides the electromagnetic waves to the detector 55. In addition, the detection half mirror 56 transmits the electromagnetic waves from the observation target OB received by the analysis objective lens 58 and guides the electromagnetic waves to the analysis camera 52. Note that, the detection half mirror 56 may be a mirror group including a plurality of half mirrors or total reflection mirrors. In addition, depending on the analysis method, the detection half mirror 56 may not be disposed.

The side illumination 58a is disposed so as to surround an outer periphery of the analysis objective lens 58. More specifically, the side illumination 58a is constituted by an annular illumination formed by annularly surrounding the analysis objective lens 58. A central axis of an annular ring corresponding to the side illumination 58a (a central axis in a case where the side illumination 58a is regarded as a ring) is disposed so as to be coaxial with the analysis optical axis Aa. The side illumination 58a emits illumination light to the analysis beam emitted from the analysis beam device 53 via an inclined optical path, and emits illumination light from obliquely above the observation target OB. Note that, although not illustrated in FIGS. 2 and 3, as the illumination of the analysis unit 50, in addition to the side illumination 58a, a coaxial illumination light source (LED light source or the like) that emits illumination light coaxially with the analysis optical axis Aa may be included in the analysis unit 50.

The analysis objective lens 58 has the analysis optical axis Aa along the vertical direction (Z direction or an upper-lower direction in the drawing). The analysis objective lens 58 receives (collects) the electromagnetic waves from the observation target OB and guides the electromagnetic waves to the detector 55 along the analysis optical axis Aa. In addition, the analysis objective lens 58 receives light (in particular, visible light) from the observation target OB and guides the light to the analysis camera 52 along the analysis optical axis Aa. Note that, additional various optical elements such as an imaging lens and an optical diaphragm may be disposed in an optical path between the analysis objective lens 58 and the analysis camera 52, and optical conditions such as a magnification and a focal length may be changeable. In addition, the analysis optical axis Aa is preferably parallel to the reference axis As of the mounting table 70. Depending on the analysis method, an irradiation path of the analysis beam, a path of the electromagnetic waves or the particles received by the detector 55, and an optical path of the analysis camera 52 may be different from each other.

Note that, as illustrated in FIG. 2, when the observation optical axis Ao of the observation unit 40 matches the observation target OB (that is, when the analysis optical axis Aa of the analysis unit 50 is out of the observation target OB), a shielding cover 59 may be disposed below the analysis objective lens 58. When the shielding cover 59 is disposed below the analysis objective lens 58, the analysis beam guided to the surface of the observation target OB through the analysis objective lens 58 is shielded by the shielding cover 59. Therefore, when the analysis optical axis Aa of the analysis unit 50 is out of the observation target OB, that is, even though the analysis beam is unintentionally emitted in a state where the analysis unit 50 is not used, the analysis beam is shielded by the shielding cover 59. Therefore, the safety of the observation apparatus 10 is improved.

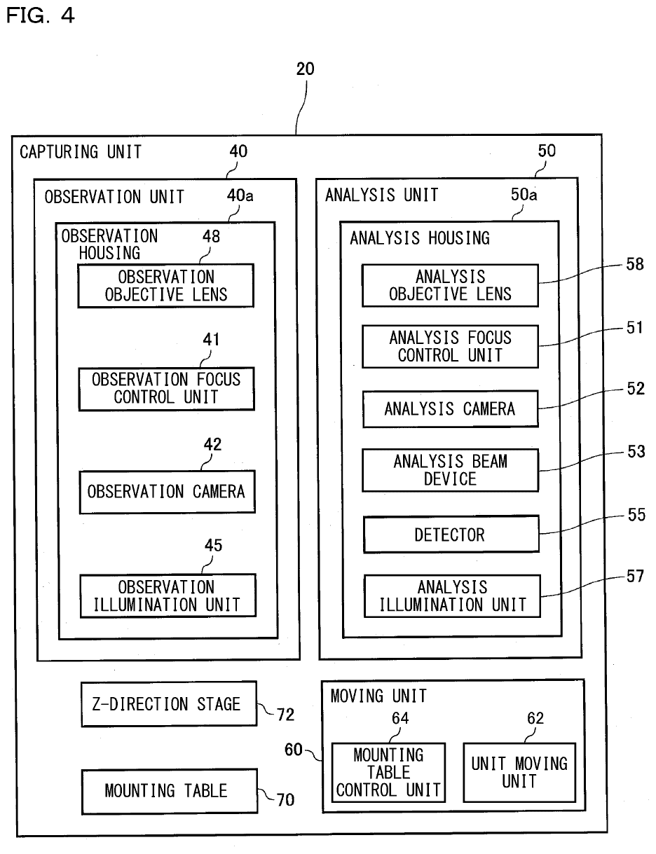

Next, a configuration of the capturing unit 20 will be described with reference to FIG. 4. FIG. 4 is a block diagram schematically illustrating the configuration of the capturing unit 20. As illustrated in FIG. 4, the capturing unit 20 includes the observation unit 40, the analysis unit 50, the moving unit 60, the mounting table 70, and the Z-direction stage 72.

As illustrated in FIG. 4, the observation unit 40 may be a unit covered with the observation housing 40a that accommodates the observation camera 42 and the observation objective lens 48. Similarly, the analysis unit 50 may be a unit covered with the analysis housing 50a that accommodates the analysis camera 52 and the analysis objective lens 58. The observation housing 40a and the analysis housing 50a are preferably separate housings. The observation unit 40 and the analysis unit 50 are units covered with different observation housings 40a and analysis housings 50a, respectively, and thus, the moving unit 60 can change the relative positions of the observation unit 40 and the analysis unit 50 with respect to the mounting table 70 by moving the observation housings 40a and the analysis housings 50a. However, the observation housing 40a and the analysis housing 50a may be the same housing, and the observation unit 40 and the analysis unit 50 may be an integrated unit.

The observation unit 40 of FIG. 4 includes an observation focus control unit 41 and an observation illumination unit 45 in addition to the observation camera 42 and the observation objective lens 48. The observation focus control unit 41 controls the lens switching unit 46, various optical elements in the observation unit 40, the Z-direction stage 72, and the like to adjust a focus of the observation objective lens 48. The observation illumination unit 45 controls various optical elements in the observation unit 40 such as the side illumination 48a and the observation half mirror 44 to adjust a state of illumination with respect to the observation target OB.

In addition to the analysis camera 52 and the analysis objective lens 58, the analysis unit 50 of FIG. 4 includes an analysis focus control unit 51, an analysis beam device 53, a detector 55, and an analysis illumination unit 57. The analysis focus control unit 51 controls various optical elements in the analysis unit 50 such as the analysis half mirror 54 and the detection half mirror 56, the Z-direction stage 72, and the like to adjust a focus of the analysis objective lens 58. The analysis illumination unit 57 controls various optical elements in the analysis unit 50 such as the side illumination 58a and the light source of the coaxial illumination to adjust a state of illumination with respect to the observation target OB.

The moving unit 60 includes a unit moving unit 62 and a mounting table control unit 64. The unit moving unit 62 moves the observation unit 40 and the analysis unit 50 in the horizontal direction to change the relative positions of the observation unit 40 and the analysis unit 50 with respect to the mounting table 70. The mounting table control unit 64 moves the mounting table 70 in the horizontal direction to change the relative positions of the observation unit 40 and the analysis unit 50 with respect to the mounting table 70.

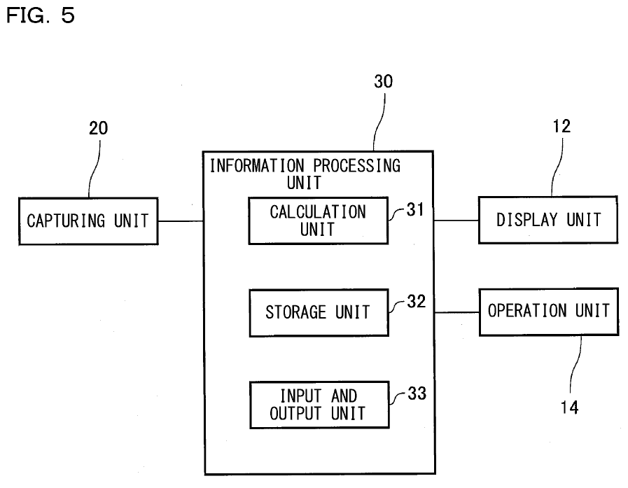

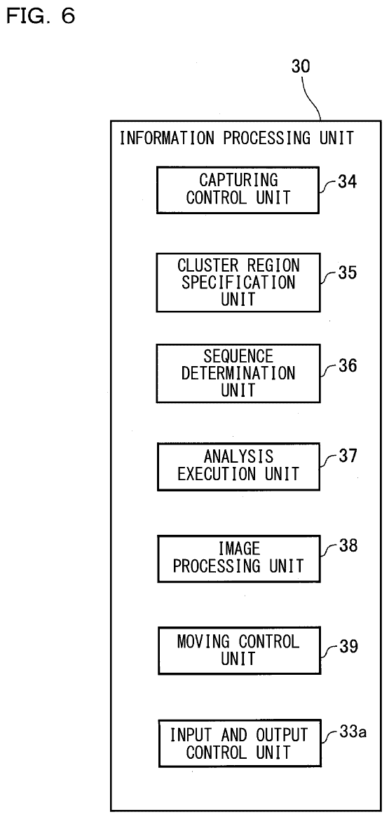

Next, a configuration of the information processing unit 30 will be described with reference to FIGS. 5 and 6. FIG. 5 is a block diagram schematically illustrating the information processing unit 30 and a communication target of the information processing unit 30. FIG. 6 is a block diagram schematically illustrating the configuration of the information processing unit 30.

As illustrated in FIG. 5, the information processing unit 30 communicates with the display unit 12, the operation unit 14, and the capturing unit 20. Since the capturing unit 20 includes the observation unit 40 and the analysis unit 50, the information processing unit 30 communicates with the observation unit 40 and the analysis unit 50.

The information processing unit 30 includes a calculation unit 31, a storage unit 32, and an input and output unit 33. The calculation unit 31 is a unit including a processor such as a CPU. The storage unit 32 is a unit including a storage device such as a RAM. The input and output unit 33 is a communication interface unit, and controls signals input to the information processing unit 30 and signals output from the information processing unit 30 in accordance with various communication standards such that the information processing unit 30 can communicate with external devices such as the capturing unit 20, the display unit 12, and the operation unit 14.

The calculation unit 31 of the information processing unit 30 executes a program stored in the storage unit 32, and thus, various functions of the information processing unit 30 illustrated in FIG. 6 are realized. As illustrated in FIG. 6, the information processing unit 30 includes a capturing control unit 34, a cluster region specification unit 35, a sequence determination unit 36, an analysis execution unit 37, an image processing unit 38, a movement control unit 39, and an input and output control unit 33a.

The capturing control unit 34 controls the observation camera 42 of the observation unit 40 to generate an observation image based on the light from the observation target OB. Note that, the capturing control unit 34 may control the analysis camera 52 of the analysis unit 50 to generate an analysis image based on the light from the observation target OB. Note that, the capturing control unit 34 may be configured to control the observation illumination unit 45 of the observation unit 40 or the analysis illumination unit 57 of the analysis unit 50 when the observation image or the analysis image is generated, and irradiate the observation target OB with the illumination light by the side illumination 48a and the coaxial illumination of the observation unit 40 or the side illumination 58a and the coaxial illumination of the analysis unit 50.

The cluster region specification unit 35 specifies a plurality of cluster regions included in the observation image. The cluster region is a region where pixels satisfying a predetermined condition (luminance, hue, saturation, and the like) in the observation image form a cluster. For example, the cluster region specification unit 35 specifies, as one cluster region, a region where pixels exceeding or falling below a threshold set for luminance (brightness) form a cluster. Note that, such a cluster region in the observation image may be referred to as “particle” or “contamination”. In the following description, a region on the observation target OB corresponding to a region observed as the cluster region in the observation image is also referred to as a “cluster region”.

The sequence determination unit 36 determines an analysis sequence in which the analysis unit 50 analyzes the cluster region for a plurality of cluster regions specified by the cluster region specification unit 35. For example, the sequence determination unit 36 specifies characteristics of each of the cluster regions by performing image processing on the observation image, and determines the analysis sequence based on the characteristics of the cluster regions, for example, a size and a shape.

The analysis execution unit 37 causes the analysis beam device 53 of the analysis unit 50 to sequentially irradiate each of the cluster regions with the analysis beam according to the analysis sequence determined by the sequence determination unit 36, and causes the analysis unit 50 to execute analysis of the cluster regions based on reaction of the cluster regions irradiated with the analysis beam (detection result of the detector 55). For example, the analysis execution unit 37 performs alignment between the analysis unit 50 and the mounting table 70 by transmitting a command to the moving unit 60. In the alignment between the analysis unit 50 and the mounting table 70, the moving unit 60 sequentially changes the relative position of the analysis unit 50 with respect to the mounting table 70 according to the analysis sequence so as to become a position where each of the cluster regions is irradiated with the analysis beam.

Then, whenever the alignment of the analysis unit 50 by the moving unit 60 is completed for each of the cluster regions, the analysis execution unit 37 causes the analysis beam device 53 to irradiate each of the cluster region with the analysis beam. The reaction of the cluster region irradiated by the analysis beam (absorbed or released energy) is detected by the detector 55. The analysis unit 50 analyzes the cluster regions based on the reaction (detection result) detected by the detector 55.

The image processing unit 38 performs image processing on the image captured by the capturing unit 20 and image processing on the image displayed on the display unit 12. For example, when the cluster region specification unit 35 specifies the cluster regions, the image processing unit 38 performs binarization processing related to luminance, size measurement processing for each of the cluster regions, and the like. In addition, when the observation image or the analysis image is displayed on the display unit 12, the image processing unit 38 performs synthesis processing of superimposing visual information for the user on the observation image or the analysis image.

The movement control unit 39 transmits a command to the moving unit 60 of the capturing unit 20 to control the movement of the observation unit 40 and the analysis unit 50 by the unit moving unit 62 and the movement of the mounting table 70 by the mounting table control unit 64.

The input and output control unit 33a controls the input and output unit 33 of the information processing unit 30 to control communication between the information processing unit 30 and an external device such as the capturing unit 20, the display unit 12, and the operation unit 14.

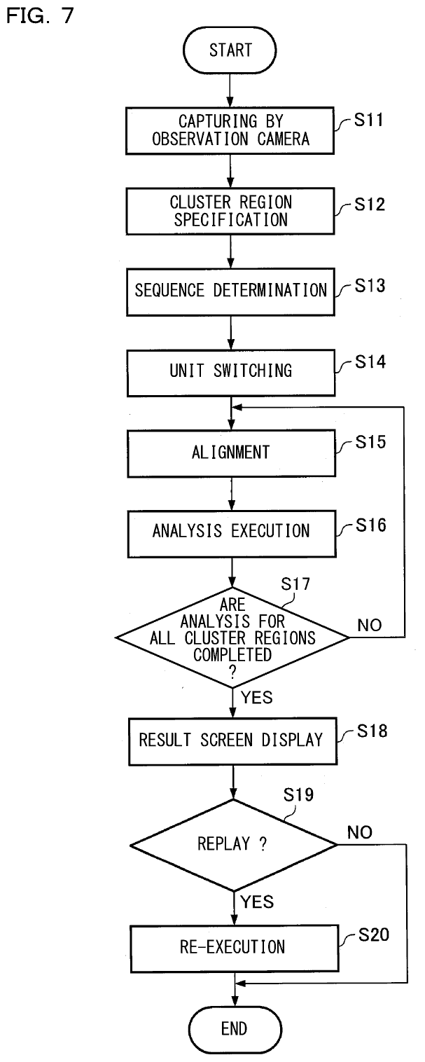

Next, a flow of the observation and analysis by the observation apparatus 10 will be described with reference to a flowchart of FIG. 7. As an example, in the following description, a case where a liquid to be analyzed is filtered with disk-shaped filter paper and foreign matters (contamination) remaining on the filter paper are observed and analyzed will be described, but the observation apparatus 10 can be used for various other operations. First, the user of the observation apparatus 10 disposes the observation target OB (for example, the filter paper having filtered the liquid) on the mounting table 70. Then, the user gives a command to start the observation and analysis on the observation target OB to the observation apparatus 10, and thus, the observation and analysis are started (START).

When the observation and analysis are started, first, in step S11, the capturing control unit 34 controls the observation camera 42 to capture the observation target OB, and thus, the observation image is generated. Here, the capturing control unit 34 may generate only one observation image obtained by capturing the entire or a part of the observation target OB by the observation camera 42, or may generate a plurality of observation images. When the plurality of observation images are generated, the capturing control unit 34 may generate a plurality of observation images by causing the observation camera 42 to capture a plurality of portions of the observation target OB while changing the relative position of the observation unit 40 with respect to the mounting table 70 by the moving unit 60.

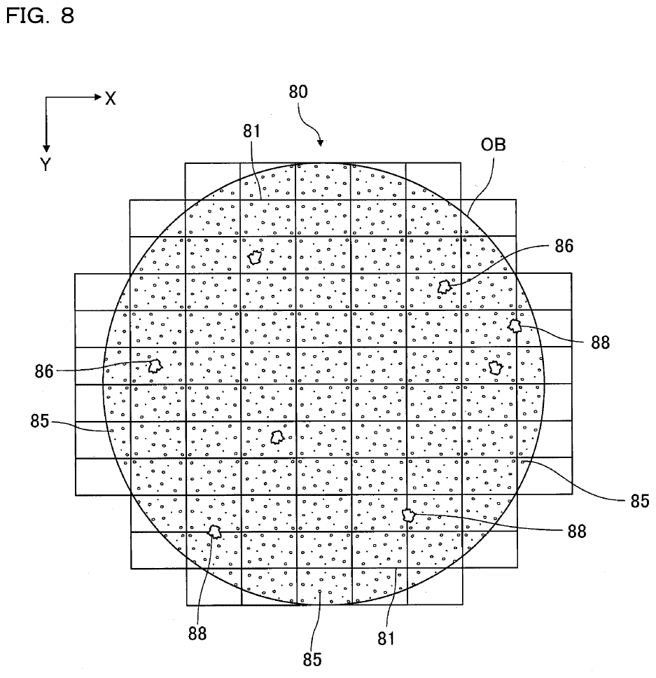

In addition, when the plurality of observation images are generated, the capturing control unit 34 may generate a coupled image 80 obtained by coupling a plurality of observation images 81. FIG. 8 illustrates an example of the coupled image 80. In FIG. 8, the coupled image 80 related to the observation target OB having a circular shape in plan view is formed by coupling the plurality of observation images 81. Each observation image 81 is generated by capturing a part of the observation target OB. The coupled image 80 generated by coupling the plurality of observation images 81 includes the entire image of the observation target OB.

Here, a capturing range of the plurality of observation images 81 by the capturing control unit 34 (a range of a capturing target to be included in the coupled image 80) may be, for example, a rectangle defined by a plurality of end points designated by the user via the operation unit 14, or a region included in a designated range from a predetermined reference point may be determined as the capturing range. In addition, the relative position of the observation unit 40 with respect to the mounting table 70 is sequentially changed by the moving unit 60 such that a visual field center of the observation camera 42 becomes three points on a circumference of the filter paper, and a circle defined based on coordinates on the mounting table 70 when the visual field center becomes three points on the circumference of the filter paper may be set as the capturing range.

Note that, in FIG. 8, the coupled image 80 is generated by coupling the plurality of observation images 81 obtained by capturing continuous regions in the observation target OB, but the coupled image 80 may be generated by coupling the plurality of observation images 81 obtained by capturing regions (discrete regions) separated from each other in the observation target OB. For example, in the observation target OB, in a case where a region to be observed and analyzed is only a part and the region to be observed and analyzed is a plurality of discrete regions, the coupled image 80 obtained by coupling the observation images 81 of the plurality of discrete regions based on stage coordinates (coordinates on the mounting table 70) may be generated.

In addition, when the observation images are generated by controlling the observation camera 42, the capturing control unit 34 may generate a plurality of observation images while changing a height of the observation unit 40 by the Z-direction stage 72. Specifically, the plurality of observation images is generated while changing the position (height) in the vertical direction while maintaining the same position of the observation unit 40 in the horizontal direction with respect to the mounting table 70. In this case, the plurality of observation images captured from different heights with respect to the observation target OB are generated.

In a case where the observation unit 40 generates the plurality of observation images at different heights with respect to the mounting table 70, the information processing unit 30 may generate a depth synthesis image or a three-dimensional image of the observation target OB based on the plurality of observation images generated at different heights. A planar shape of the observation target OB appears in each observation image, and a portion in focus in the observation image corresponds to the height of the observation unit 40 when the observation image is captured. Therefore, it is possible to generate the depth synthesis image or the three-dimensional image of the observation target OB by synthesizing (performing depth synthesis of) the plurality of observation images at the portion in focus in each observation image.

When the capturing by the observation camera 42 is completed, next, in step S12 of FIG. 7, the cluster region specification unit 35 specifies the plurality of cluster regions included in the observation image. Here, the cluster region specification unit 35 may accept designation of an extraction condition for specifying the cluster regions from the observation image, and may specify (extract), as the cluster regions, regions of the observation image matching the extraction condition. Note that, the extraction condition may be determined in advance.

For example, in step S12, a screen for accepting designation of the extraction condition may be displayed on the display unit 12, and the extraction condition may be set in accordance with an operation of the user on the screen through the operation unit 14. For example, the user designates a luminance threshold, and in the observation image, a region where pixels having luminance exceeding the designated threshold or falling below a specific threshold form a cluster is specified as the cluster region.

For example, as illustrated in FIG. 8, in the observation image (here, the coupled image 80) obtained by capturing the filter paper having filtered the liquid, in a case where the foreign matters remaining on the filter paper are specified as cluster regions 85, since the foreign matters appear as dark regions, regions below the designated luminance threshold may be specified as the cluster regions 85.

Note that, in a case where the coupled image 80 is generated by coupling the plurality of observation images 81 as illustrated in FIG. 8, the cluster region specification unit 35 may specify the plurality of cluster regions included in the coupled image 80. In the coupled image 80, there may be cluster regions 88 across the plurality of observation images 81. The cluster region specification unit 35 may specify the cluster region 88 across the plurality of observation images 81 as one cluster region in the coupled image 80. In a case where the cluster region is specified for each observation image 81, there is a possibility that the cluster region 88 across the plurality of observation images 81 is specified as a single cluster region in each of the two observation images 81 and is regarded as two cluster regions as a whole. However, in a case where the cluster region is specified for the entire coupled image 80, the cluster region is correctly specified as one cluster region.

In addition, the cluster region specification unit 35 may specify a size of each of the cluster regions when the cluster region is specified. Then, the user may designate the size of the cluster region as the extraction condition. In a case where the size of the cluster region is designated as the extraction condition, only the regions matching the designated size condition are specified as the cluster regions, and the other regions are excluded. For example, as illustrated in FIG. 8, in a case where the small cluster regions 85 and the large cluster regions 86 are mixed, when the size condition is designated so as to exclude the small cluster regions 85, only the large cluster regions 86 (and the large cluster regions 88 across the plurality of observation images 81) are regarded as the cluster regions, and the small cluster regions 85 are not regarded as the cluster regions.

In addition, in a case where the three-dimensional image of the observation target OB is generated, the cluster region specification unit 35 may specify the height of each of the cluster regions based on the three-dimensional image.

In addition, the cluster region specification unit 35 may classify the plurality of cluster regions into two or more attributes. When the characteristics of the cluster regions are specified, the cluster region specification unit 35 may classify cluster regions having similar characteristics as cluster regions having the same attribute. For example, the cluster region specification unit 35 may classify a plurality of cluster regions having sizes within a specific range as the cluster regions having the same attribute, or may classify a plurality of cluster regions having a specific color or luminance value as the cluster regions having the same attribute. In this case, for example, relatively bright cluster regions may be determined as metal based on luminance values of a plurality of pixels included in the cluster region, such as classifying cluster regions having high average luminance of pixels as metal.

When the specification of the cluster regions by the cluster region specification unit 35 is completed, next, in step S13 of FIG. 7, the analysis sequence is determined by the sequence determination unit 36. For example, the sequence determination unit 36 determines the analysis sequence in the order of the cluster regions found by searching for the observation image from an end.

Specifically, the sequence determination unit 36 first searches for the cluster regions rightward in the X direction from the coupled image 80 illustrated in FIG. 8 with a range near an upper end in the observation target OB as a search range, sets the cluster region found first as a first cluster region in the analysis sequence, and thereafter, determines the analysis sequence in the order of finding. Then, when the search is completed up to a right end in the X direction, the search range is slightly shifted in the Y direction, and the cluster regions are searched for again rightward in the X direction. When the search of the cluster regions is completed at a lower end in the observation target OB, the analysis sequence is determined for all the cluster regions in the observation target OB.

In addition, in a case where the cluster region specification unit 35 specifies the size of each of the cluster regions in step S12 of FIG. 7, the sequence determination unit 36 may determine the analysis sequence based on the size of the cluster region in step S13. In addition, the sequence determination unit 36 may determine the cluster region as an analysis target (which cluster region is to be irradiated with the analysis beam) based on the size of the cluster region.

For example, the sequence determination unit 36 may determine the analysis sequence in descending order of the size of the cluster region. Since there is a high possibility that the user is interested in the large cluster region, the analysis is performed in order of interest of the user by performing the analysis in descending order, and there is a high possibility that the analysis sequence is as desired by the user.

On the other hand, the sequence determination unit 36 may determine the analysis sequence in ascending order of the size of the cluster region. For example, in a case where the analysis method performed by the analysis unit 50 is a method for imparting an irreversible change to the observation target OB (destructive inspection), when a change occurs in the large cluster region, there is a possibility that the small cluster region is affected by the change. In such a case, the analysis is performed in ascending order, and thus, it is possible to more accurately analyze the small cluster region before being affected by the analysis for the large cluster region without omission.

Further, in a case where the cluster regions as the analysis target are determined based on the size of the cluster region, for example, the sequence determination unit 36 may accept designation of the size of the cluster region as the analysis target by the user, and may determine, as the cluster region as the analysis target, cluster regions having sizes larger than the designated predetermined size. Then, the sequence determination unit 36 determines the analysis sequence of the cluster regions as the analysis target. Note that, the sequence determination unit 36 may set, as the cluster regions as the analysis target, cluster regions having sizes smaller than the predetermined size designated by the user.

In addition, in a case where the three-dimensional image of the observation target OB is generated and the cluster region specification unit 35 specifies the height of each of the cluster regions, the sequence determination unit 36 may determine the analysis sequence based on the size and the height of the cluster region. Since the three-dimensional size of the cluster region can be specified from the size and height of the cluster region, the sequence determination unit 36 may determine the analysis sequence based on a three-dimensional size of the cluster region. For example, the analysis sequence may be determined in descending order of the three-dimensional size or in ascending order of the three-dimensional size.

In addition, the sequence determination unit 36 may accept designation of a priority related to the cluster region, and may determine the analysis sequence based on the designation of the priority. For example, in step S13, a screen for accepting the designation of the priority is displayed on the display unit 12, and the priority may be designated in accordance with an operation of the user on the screen through the operation unit 14. For example, the user designates cluster regions to be preferentially analyzed as cluster regions with a high priority. Then, the sequence determination unit 36 determines the analysis sequence in descending order of the designated priority.

Note that, in a case where the user designates the priority, the priority may not be designated for all the cluster regions. In a case where the user designates the priority only for some cluster regions, the sequence determination unit 36 may automatically determine the analysis sequence for the cluster regions for which the priority is not designated. For example, the sequence determination unit 36 may divide the analysis sequence into a first sequence and a second sequence executed subsequently to the first sequence. Then, in the first sequence, the analysis sequence may be determined based on the priority designated by the user, and in the second sequence, the analysis sequence related to the cluster region for which the priority is not designated may be determined. The analysis sequence in the second sequence may be determined, for example, in the order found by searching for the observation image from the end, or may be determined based on the size of the cluster region.

In addition, in a case where the cluster region specification unit 35 classifies the cluster region into two or more attributes, the sequence determination unit 36 may determine the analysis sequence based on the attribute of the cluster region. For example, the sequence determination unit 36 may set the analysis sequence of the cluster regions classified into the same attribute to a continuous sequence, or sets the analysis sequence of the cluster regions classified into a specific attribute to an early sequence or a late sequence. In addition, the sequence determination unit 36 may set, as the analysis target, only the cluster regions classified into the specific attribute by the cluster region specification unit 35, and may determine the analysis sequence of the cluster regions having the specific attribute. In a case where the analysis sequence is determined based on the attribute of the cluster region, the sequence determination unit 36 may determine the attribute of each of the cluster regions and may determine the analysis sequence of the cluster region as the analysis target based on the determination result of the attribute.

When the analysis sequence is determined by the sequence determination unit 36, next, in step S14 in FIG. 7, unit switching from the observation unit 40 to the analysis unit 50 is performed. That is, the moving unit 60 changes the relative position of the analysis unit 50 with respect to the mounting table 70 such that a portion of the observation target OB where the observation image is captured by the observation camera 42 is irradiated with the analysis beam. Note that, in a case where the observation unit 40 and the analysis unit 50 are an integrated unit, unit switching from the observation unit 40 to the analysis unit 50 is not performed.

More specifically, regarding the unit switching in step S14, the relative position of the analysis unit 50 with respect to the mounting table 70 is changed such that the visual field center of the observation camera 42 coincides with a visual field center of the analysis camera 52 and an irradiation point of the analysis beam by the analysis beam device 53.

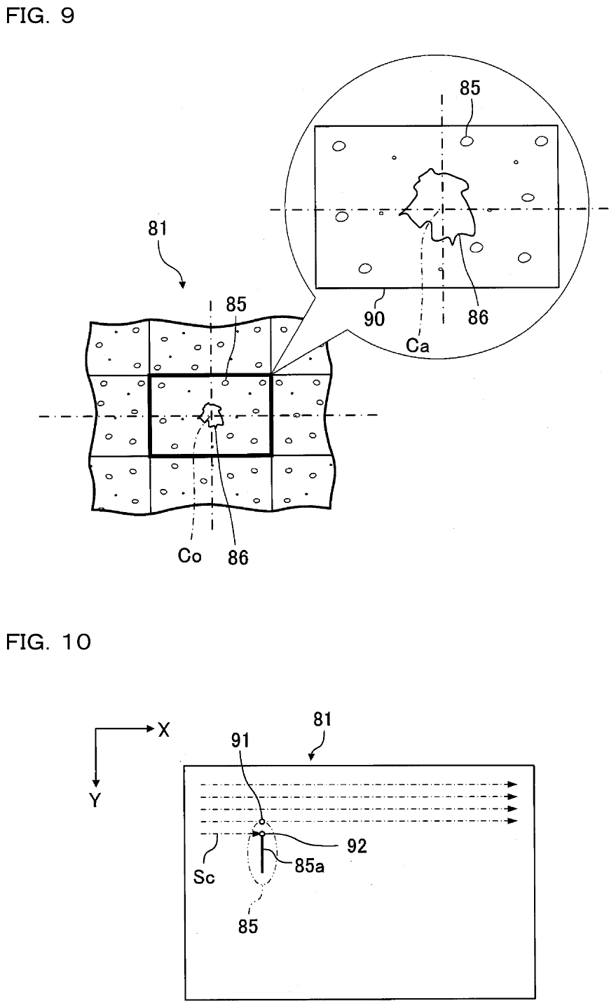

The fact that the visual field center of the observation camera 42 coincides with the visual field center of the analysis camera 52 will be described with reference to FIG. 9. FIG. 9 is a diagram illustrating a relationship between the observation image 81 and an analysis image 90. As illustrated in FIG. 9, in a case where a visual field center Co of the observation image 81 captured by the observation camera 42 matches the large cluster region 86, after the unit switching, in the analysis image 90 captured by the analysis camera 52, the relative position of the analysis unit 50 with respect to the mounting table 70 is changed such that a visual field center Ca of the analysis image 90 also matches the same large cluster region 86. In the present embodiment, when the analysis beam guided by the analysis half mirror 54 of the analysis unit 50 is coaxial with the analysis optical axis Aa of the analysis objective lens 58, the analysis beam is irradiated to the visual field center Ca of the analysis image 90.

At the time of unit switching, the unit moving unit 62 of the moving unit 60 or the mounting table control unit 64 horizontally moves the analysis unit 50 or the mounting table 70 by the same distance as the distance between the observation optical axis Ao and the analysis optical axis Aa. However, when the analysis unit 50 or the mounting table 70 is merely horizontally moved, the visual field center Co of the observation image 81 and the visual field center Ca of the analysis image 90 (and the irradiation point of the analysis beam) may be deviated from each other. Therefore, a deviation amount between the visual field centers generated when the switching between the observation unit 40 and the analysis unit 50 is performed may be calculated in advance, and a movement amount by the moving unit 60 may be corrected by the deviation amount calculated in advance at the time of unit switching.

Note that, in the unit switching in step S14 (when the relative position of the analysis unit 50 with respect to the mounting table 70 is changed such that the portion where the observation image is captured is irradiated with the analysis beam), the moving unit 60 preferably adjusts the relative position of the analysis unit 50 with respect to the mounting table 70 in accordance with an optical magnification of the observation objective lens 48 of the observation unit 40 when the observation image 81 is generated. Specifically, a movement amount corresponding to the optical magnification of the observation objective lens 48 of the observation unit 40 when the observation image is generated may be calculated, and the relative position of the analysis unit 50 with respect to the mounting table 70 may be adjusted based on the calculated movement amount. For example, in a case where the lens switching unit 46 of the observation unit 40 includes a plurality of observation objective lenses 48, the deviation amount between the visual field center Co of the observation image 81 and the visual field center Ca of the analysis image 90 varies depending on which observation objective lens 48 was used when the observation image 81 was generated. Therefore, the deviation amount between the visual field centers may be calculated in advance for each optical magnification of the observation objective lenses 48, and at the time of unit switching, the movement amount by the moving unit 60 may be corrected by the deviation amount calculated in advance in accordance with the optical magnification of the observation objective lens 48. Note that, the adjustment of the relative position of the analysis unit 50 with respect to the mounting table 70 corresponding to the optical magnification of the observation objective lens 48 is not limited to a case where the observation objective lens 48 is switched. For example, at the time of switching the imaging lens or changing the magnification by the zoom lens, the movement amount by the moving unit 60 may be corrected by the deviation amount calculated in advance in accordance with the optical magnification of the observation objective lens 48.

In addition, when the movement amount is merely corrected by the moving unit 60 by the deviation amount between the visual field centers calculated in advance to match the visual field center Co of the observation image 81 with the visual field center Ca of the analysis image 90, the alignment may be deviated when the relative position of the analysis unit 50 with respect to the mounting table 70 is changed and the alignment with respect to each cluster region is performed in the next step S15. Therefore, it is preferable that a correspondence relationship between one pixel in the observation image and an actual distance (or necessary movement amount) is stored for each optical magnification of the observation objective lens 48 and the movement amount by the moving unit 60 is calibrated based on the correspondence relationship.

When the unit switching from the observation unit 40 to the analysis unit 50 is completed, next, in step S15 of FIG. 7, the moving unit 60 aligns the analysis unit 50 and the mounting table 70 according to the analysis sequence determined by the sequence determination unit 36.

That is, the moving unit 60 sequentially changes the relative position of the analysis unit 50 with respect to the mounting table 70 according to the analysis sequence determined by the sequence determination unit 36 so as to become a position where each of the cluster regions is irradiated with the analysis beam. The moving unit 60 first moves the analysis unit 50 or the mounting table 70 such that the relative position of the analysis unit 50 with respect to the mounting table 70 becomes a position corresponding to the first cluster region in the analysis sequence. Then, when the analysis is executed on the first cluster region, the moving unit 60 then moves the analysis unit 50 or the mounting table 70 to a position corresponding to the second cluster region in the analysis sequence. The moving unit 60 sequentially repeats this movement according to the analysis sequence.

Note that, the moving unit 60 may change the irradiation point of the analysis beam by a method such as rotating the optical element such as the analysis half mirror 54 or using a deflector that deflects the analysis beam without changing the relative position of the analysis unit 50 with respect to the mounting table 70. In addition, both processing of changing the irradiation point by the rotation of the optical element or the polarization of the analysis beam and processing of changing the irradiation point by the movement by the moving unit 60 may be used while being switched based on the determination of whether or not the rotation of the optical clement or the polarization of the analysis beam is more advantageous than the movement by the moving unit 60. The determination as to whether or not the processing of changing the irradiation point without performing the movement is more advantageous than the movement by the moving unit 60 may be performed based on, for example, a time required for the execution, the analysis accuracy, and the like.

When the alignment of the analysis unit 50 and the mounting table 70 by the moving unit 60 is completed, next, in step S16 of FIG. 7, the analysis of the cluster regions by the analysis unit 50 is executed. Specifically, the analysis beam 53 irradiates the cluster region with the analysis beam, the detector 55 detects the reaction of the cluster region (a part of the observation target OB) irradiated with the analysis beam, and the cluster region is analyzed based on the detection result of the detector 55.

In the analysis of the cluster regions by the analysis unit 50, various analysis methods may be adopted. For example, in a case where analysis is performed by Laser-Induced Breakdown Spectroscopy (LIBS), the analysis unit 50 uses a high energy laser as the analysis beam, locally plasmatizes the cluster region by the analysis beam, and performs analysis based on a spectrum of light generated by the plasmatized cluster region. The plasmatized cluster region emits each component of an element in the cluster region and an electromagnetic wave having a wavelength corresponding to a content of each component. The detector 55 detects the energy released from the observation target OB or the energy absorbed by the observation target OB based on the electromagnetic wave generated from the plasmatized cluster region. The analysis by the LIBS is a so-called destructive inspection, and it is possible to specify each component of the element included in the cluster region and a content thereof.

In addition, in a case where the analysis by the LIBS is performed, the analysis unit 50 preferably generates the analysis image by capturing the observation target OB by the analysis camera 52 before the cluster region is irradiated with the analysis beam. Since the analysis by the LIBS is the destructive inspection, the analysis image before the cluster region is irradiated with the analysis beam is generated, and thus, a state before an irreversible change occurs in the cluster region by the analysis beam can be confirmed after the analysis.

In addition, in a case where analysis is performed by the LIBS, the analysis unit 50 preferably generates the analysis image by the analysis camera 52 even after the cluster region is irradiated with the analysis beam. The analysis image after the analysis beam is irradiated is generated, and thus, it is possible to compare the state before the irreversible change occurs in the cluster region by the analysis beam and the state after the change occurs.

In addition, the analysis image generated by capturing the observation target OB by the analysis camera 52 before the cluster region is irradiated with the analysis beam, the analysis image generated by capturing the observation target OB by the analysis camera 52 after the cluster region is irradiated with the analysis beam, and a result of analysis of the cluster region (for example, each component of the element included in the cluster region and the content thereof) may be stored in the storage unit 32 in association with each other. By doing so, it is possible to easily compare an analysis result of a predetermined cluster region with the analysis images before and after the analysis.

In addition, the analysis unit 50 can also analyze the cluster regions by an analysis method other than LIBS. For example, the analysis unit 50 may perform analysis by a scanning electron microscope/energy dispersive X-ray spectroscopy (SEM/EDS) method. In the SEM/EDS method, the analysis unit 50 emits the electron beam as the analysis beam, and performs analysis based on electrons or characteristic X-rays emitted from the cluster region with respect to the emission of the electron beam. The electrons emitted from the cluster region with respect to the emission of the electron beam are electrons of atoms of the cluster region that are flipped off by the electron beam of the analysis beam. Note that, the characteristic X-rays emitted from the cluster region with respect to the emission of the electron beam are X-rays released in accordance with an energy difference before and after the movement when electrons at a higher energy level move to vacancies in order to fill the vacancies caused by the electrons of the atoms of the cluster region being flipped off. The detector 55 detects the energy released from the observation target OB or the energy absorbed by the observation target OB based on the electrons or the characteristic X-rays generated from the cluster region.

In addition, the analysis unit 50 may perform analysis by an X-Ray Fluorescence (XRF) method. In the XRF method, the analysis unit 50 emits the X-rays as the analysis beam, and performs analysis based on the characteristic X-rays emitted from the cluster region with respect to the emission of the X-rays. Similarly to the SEM/EDS method, the characteristic X-rays emitted from the cluster region with respect to the emission of the X-rays are X-rays released in accordance with an energy difference before and after the movement when the electrons at a higher energy level move to vacancies in order to fill the vacancies generated by the electrons being flipped off by the emission of the X-rays. The detector 55 detects the energy released from the observation target OB or the energy absorbed by the observation target OB based on the characteristic X-rays generated from the cluster region.

In addition, the analysis unit 50 may perform analysis by Raman spectroscopy. In the Raman spectroscopy, the analysis unit 50 performs analysis based on Raman scattered light generated from the cluster region at a wavelength different from a wavelength of incident light emitted as the analysis beam. The scattered light generated as a result of the incident light colliding with molecules of a substance to be analyzed is mostly light having the same wavelength as the incident light (Rayleigh scattered light), but includes light having a wavelength slightly different from a wavelength of the incident light (Raman scattered light). Since the Raman scattered light is generated by interaction between the incident light and the substance to be analyzed, a molecular structure or the like to be analyzed can be analyzed by examining a peak or a spectrum of the Raman scattered light. The detector 55 detects the energy released from the observation target OB or the energy absorbed by the observation target OB based on the Raman scattered light generated from the cluster region.

The analysis unit 50 may perform analysis by infrared spectroscopy. In the infrared spectroscopy, the analysis unit 50 emits infrared light as the analysis beam, and performs analysis based on light transmitted through the cluster region or light reflected by the cluster region. Comparing the light transmitted through the analysis target or the light reflected by the analysis target with the emitted infrared light, since a wavelength of the infrared light absorbed by the analysis target is known, an absorption wavelength spectrum of the substance with respect to the infrared light can be analyzed.

The analysis unit 50 may perform analysis using a photothermal effect. In the analysis using the photothermal effect, for example, the analysis unit 50 performs analysis based on thermal expansion of the cluster region by the irradiation of the analysis beam by using a beam that thermally expands the cluster region such as the infrared light as the analysis beam. A degree to which the infrared light is absorbed by the substance to be analyzed depends on the wavelength of the infrared light. The greater the degree to which the infrared light is absorbed by the substance, the higher a temperature of the substance. Therefore, the absorption wavelength spectrum of the substance with respect to the infrared light can be analyzed by examining the wavelength of the infrared light and a change in characteristics such as thermal expansion correlated with a temperature rise of the substance corresponding to each wavelength based on the displacement generated in the observation target OB. In addition, in the analysis using the photothermal effect, the analysis unit 50 may emit the infrared light and a refraction detection laser as the analysis beam, and perform analysis based on a change in a refractive index of a refraction detection laser caused by a temperature change of the cluster region due to the irradiation of the infrared light. When the cluster region as the analysis target absorbs the infrared light, the refractive index changes due to the temperature rise. Therefore, it is possible to analyze the absorption wavelength spectrum of the analysis target with respect to the infrared light by examining the change in the refractive index of the refraction detection laser (the change in the refractive index of the cluster region due to the irradiation of the infrared light) by using the refractive index meter. Note that, the examining (observing) of the phenomenon (thermal expansion or the like) caused by the temperature change of the cluster region corresponds to the detector 55 detecting the energy absorbed by the observation target OB by the irradiation of the analysis beam. In the analysis using the photothermal effect, a unit that observes the change in characteristics such as the thermal expansion of the cluster region based on the image of the cluster region included in the analysis image captured by the analysis camera 52 functions as the detector 55.

Note that, when analysis using the analysis beam is performed, the analysis unit 50 captures the observation target OB by the analysis camera 52 to generate the analysis image, and controls the analysis focus control unit 51 to irradiate the analysis beam by the analysis beam device 53 in a state where the analysis camera 52 is focused on the cluster region as the analysis target. Since the analysis optical axis Aa of the analysis camera 52 is coaxial with the analysis beam, in a state where the analysis camera 52 is focused on the cluster region as the analysis target, the cluster region is irradiated with the analysis beam most efficiently.

Note that, in order to reliably irradiate the cluster region with the analysis beam, it is preferable that the analysis unit 50 finely adjusts the irradiation point of the analysis beam based on the observation image generated by the observation camera 42 or the analysis image generated by the analysis camera 52. For example, the analysis unit 50 may irradiate a geometric center of gravity of the cluster region calculated based on the observation image with the analysis beam.

In many cases, since the geometric center of gravity of the cluster region is positioned inside the cluster region, the analysis beam can be reliably applied to the cluster region by irradiating the geometric center of gravity of the cluster region with the analysis beam. In a case where the irradiation point of the analysis beam does not match the geometric center of gravity of the cluster region, the analysis unit 50 changes the irradiation point of the analysis beam by changing the relative position between the mounting table 70 and the analysis unit 50 by the moving unit 60. Note that, the analysis unit 50 may change the irradiation point of the analysis beam without changing the relative position between the mounting table 70 and the analysis unit 50 by the moving unit 60 such as rotating the optical element such as the analysis half mirror 54 or using the deflector that deflects the analysis beam.

In addition, the analysis unit 50 may determine the irradiation point of the analysis beam using thinning processing. FIG. 10 illustrates a case where the analysis unit 50 determines the irradiation point of the analysis beam by using the thinning processing. The cluster region appears in the observation image 81 is referred to as the cluster region 85. The thinning processing is performed on the cluster region 85, and thus, a thinned region 85a is obtained. In the thinning processing, pixels in the cluster region 85 are shrunk from an outer peripheral portion by pixel by pixel, and a continuous body of pixels corresponding to one pixel remaining last is defined as the thinned region 85a. The analysis unit 50 irradiates a portion (thinned end portion 92) corresponding to an end portion of the thinned region 85a obtained in this manner with the analysis beam. As illustrated in FIG. 10, the thinned end portion 92 searches for the cluster region 85 from an end of the observation image 81, and is positioned inside the cluster region 85 more than a portion (cluster region end portion 91) where a search path Sc first intersects the cluster region 85. Therefore, the irradiation point of the analysis beam is determined by using the thinning processing, and thus, the analysis unit 50 can reliably apply the analysis beam to the cluster region 85.

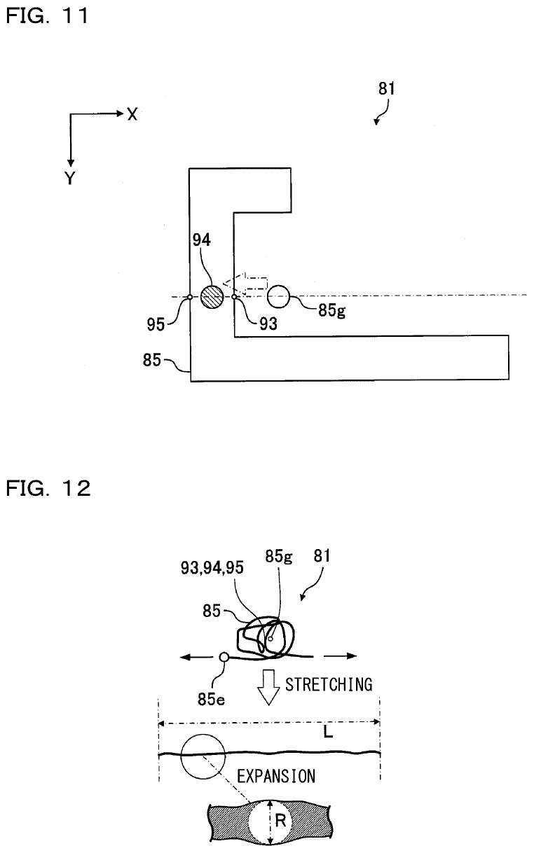

In addition, depending on a shape of the cluster region 85, a geometric center of gravity 85g of the cluster region 85 may be outside the cluster region 85. As illustrated in FIG. 11, in a case where the geometric center of gravity 85g of the cluster region 85 is outside the cluster region 85 in the observation image 81, the analysis unit 50 may irradiate a nearest end portion 93 of the cluster region 85 closest to the geometric center of gravity 85g of the cluster region 85 along a first direction in the analysis image 90 with the analysis beam. That is, the analysis unit 50 does not set the geometric center of gravity 85g of the cluster region 85 as the irradiation point of the analysis beam, but searches for the cluster region 85 along any direction (the horizontal direction or is the X direction in FIG. 10 but may be the Y direction) in the observation image 81 from the geometric center of gravity 85g, and sets the portion (nearest end portion 93) of the cluster region 85 closest to the geometric center of gravity 85g along a search direction as the irradiation point of the analysis beam. By doing so, even in a case where the geometric center of gravity 85g of the cluster region 85 is outside the cluster region 85, the analysis unit 50 can apply the analysis beam to the cluster region 85.

Note that, as illustrated in FIG. 11, the analysis unit 50 may search for the nearest end portion 93 of the cluster region 85 and a far end portion 95 that is an outer end of the cluster region 85 along the first direction (here, the X direction) from the nearest end portion 93, and may irradiate a central portion 94 between the nearest end portion 93 and the far end portion 95 with the analysis beam. The analysis unit 50 irradiates the central portion 94 with the analysis beam, and thus, the analysis beam can be applied to a portion inside the cluster region 85.

In addition, the analysis unit 50 determines whether or not the cluster region 85 is a fiber based on the observation image 81, and when the cluster region 85 is the fiber, a portion (fiber end portion 85e) corresponding to an end portion in a case where the cluster region 85 is thinned, the nearest end portion 93 or the central portion 94 between the nearest end portion 93 and the far end portion 95 may be irradiated with the analysis beam. FIG. 12 illustrates a case where the cluster region 85 is a fiber. The determination as to whether or not the cluster region 85 is the fiber is performed by the following procedure.

First, the analysis unit 50 stretches the cluster region 85 for which it is determined whether the cluster region is the fiber in a straight line by image processing, and measures a stretched length L. Then, the analysis unit 50 also measures a maximum inner diameter R of the cluster region 85 stretched in the straight line. When a size of L with respect to R exceeds 20 (L/R>20) and the maximum inner diameter R is 50 μm or less, the cluster region 85 is determined to be the fiber.

In a case where it is determined that the cluster region 85 is the fiber, the analysis unit 50 may perform the thinning processing on the cluster region 85 and may irradiate the portion (fiber end portion 85c) corresponding to an end portion of the thinned cluster region 85 with the analysis beam. The fiber end portion 85e is irradiated with the analysis beam, and thus, the analysis unit 50 can apply the analysis beam even though the cluster region 85 is the fiber. Alternatively, the analysis unit 50 may obtain the geometric center of gravity 85g of the cluster region 85 determined to be the fiber, may search for the nearest end portion 93 from the geometric center of gravity 85g, and may set the nearest end portion 93 as the irradiation point, similarly to the case illustrated in FIG. 11. Alternatively, the analysis unit 50 may search for the nearest end portion 93 and the far end portion 95 from the geometric center of gravity 85g, and set the central portion 94 therebetween as the irradiation point. Note that, in FIG. 12, since the nearest end portion 93, the central portion 94, and the far end portion 95 are gathered at very close positions, these end portions are illustrated as the same position, but actually, as illustrated in FIG. 11, the nearest end portion 93, the central portion 94, and the far end portion 95 are separate positions.

In step S16 of FIG. 7, the analysis unit 50 executes the above analysis for each of the cluster regions. Then, in step S17, it is determined whether or not analysis has been completed for all the cluster regions whose analysis sequence has been determined by the sequence determination unit 36. In a case where the analysis for all the cluster regions is not completed (NO in step S17), the observation apparatus 10 returns to step S15, and aligns the analysis unit 50 and the mounting table 70 with respect to the cluster region in the next order in the analysis sequence.

Note that, in step $15, the moving unit 60 may accept a correction operation for correcting the relative position of the analysis unit 50. In particular, the correction operation is preferably accepted when the moving unit 60 sets the relative position of the analysis unit 50 with respect to the mounting table 70 as a position corresponding to the first cluster region in the analysis sequence.

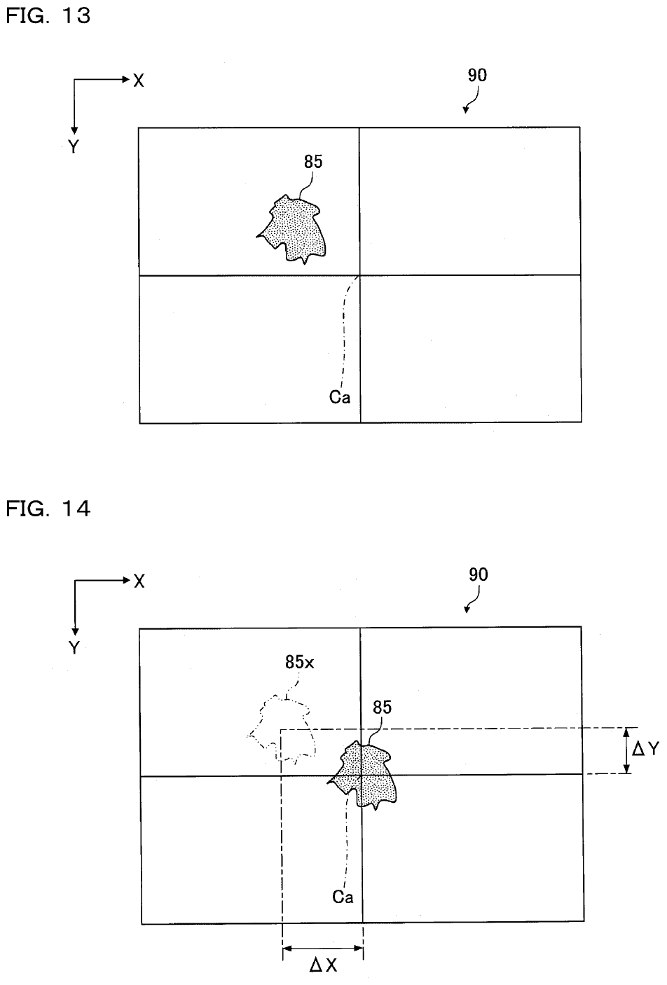

As illustrated in FIG. 13, when the moving unit 60 sets the relative position of the analysis unit 50 with respect to the mounting table 70 as the position corresponding to the first cluster region 85 in the analysis sequence, the position of the cluster region 85 in the analysis image 90 may not coincide with the visual field center Ca of the analysis image 90. Even though the movement amount is calibrated by the moving unit 60, such deviation may occur due to mechanical rattling or the like of a mechanism. Therefore, when the moving unit 60 sets the relative position of the analysis unit 50 with respect to the mounting table 70 as the position corresponding to the first cluster region 85 in the analysis sequence, the analysis image 90 is displayed on the display unit 12, and the correction operation by the user is accepted.

The user who has confirmed that the position of the cluster region 85 in the analysis image 90 does not coincide with the visual field center Ca of the analysis image 90 performs the correction operation via the operation unit 14, and changes the relative position of the analysis unit 50 with respect to the mounting table 70 such that the visual field center Ca of the analysis image 90 coincides with the position of the cluster region 85.

FIG. 14 is a diagram illustrating a case where the moving unit 60 accepts the correction operation by the user. The moving unit 60 stores a change amount in the relative position of the analysis unit 50 corrected by the correction operation. In FIG. 14, a relative position of the position of the cluster region 85 in the analysis image 90 is corrected by ΔX in the X direction and ΔY in the Y direction from a position 85x before correction by the correction operation. The information processing unit 30 stores a displacement amount corrected by the correction operation in the storage unit 32.

The moving unit 60 corrects the relative position of the analysis unit 50 corresponding to a second or subsequent cluster region in the analysis sequence by the correction operation, and corrects the relative position based on the displacement amount stored in the storage unit 32. That is, after the analysis for the first cluster region 85 in the analysis sequence is completed in step S16 of FIG. 7, the processing returns to step S15, and when the relative position of the analysis unit 50 with respect to the mounting table 70 is aligned with the position corresponding to the second or subsequent cluster region in the analysis sequence, the moving unit 60 corrects the relative position of the analysis unit 50 based on the stored displacement amount (ΔX in X direction and ΔY in Y direction). As a result, the correction accepted by the correction operation is reflected in the alignment with respect to all the cluster regions included in the analysis sequence.

Note that, in the above example, in the alignment in step S15, when the relative position of the analysis unit 50 with respect to the mounting table 70 is set to the position corresponding to the first cluster region 85 in the analysis sequence, in a case where the position of the cluster region 85 in the analysis image 90 does not coincide with the visual field center Ca of the analysis image 90, the operation of adjusting the visual field center Ca to the cluster region 85 is accepted as the correction operation by the user. However, designation of any cluster region 85 by the user may be accepted as the correction operation by the moving unit 60. In this case, the information processing unit 30 accepts the designation of any cluster region 85 as the correction operation of correcting the relative position of the analysis unit 50 such that the relative position of the analysis unit 50 with respect to the mounting table 70 becomes the position corresponding to the predetermined (designated) cluster region 85. When any cluster region 85 is designated, the moving unit 60 changes the relative position of the analysis unit 50 with respect to the mounting table 70 such that the visual field center Ca of the analysis image 90 coincides with the position of the (predetermined) cluster region 85 designated by the user. The information processing unit 30 stores the displacement amount of the relative position at this time as the corrected displacement amount (stores the displacement amount in the storage unit 32). Then, when the relative position of the analysis unit 50 with respect to the mounting table 70 is aligned with the position corresponding to each cluster region, the moving unit 60 may correct the relative position of the analysis unit 50 by the stored displacement amount.

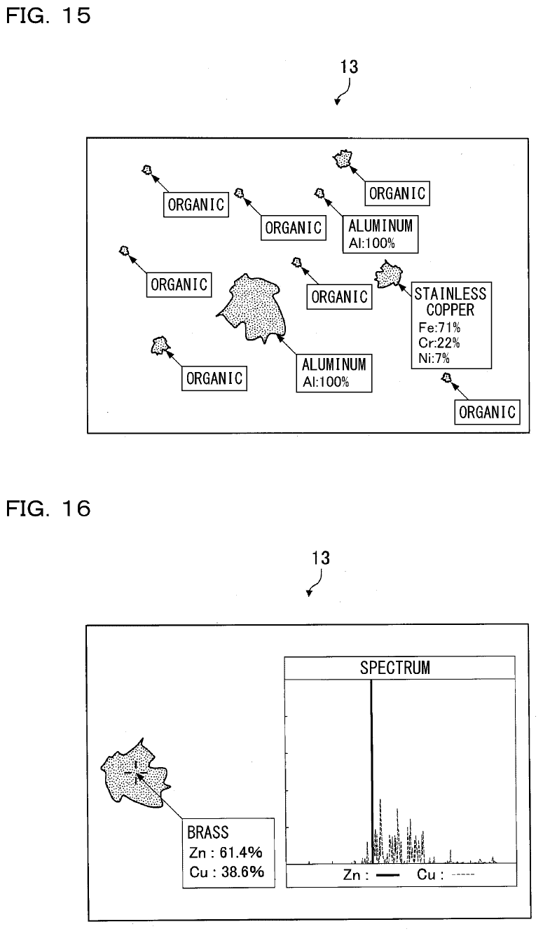

When the above processes are repeated and the analysis for all the cluster regions is completed (YES in step S17 in FIG. 7), the observation apparatus 10 proceeds to step S18 and displays a result screen 13 on the display unit 12. FIG. 15 illustrates an example of the result screen 13.

The result screen 13 of FIG. 15 displays a result of component analysis performed on each cluster region. A case where the cluster region is organic, aluminum, or stainless copper is illustrated on the result screen 13. For a substance in which a plurality of elements are mixed, such as stainless copper, components of the substance and contents thereof are also illustrated.

In addition, in a case where spectrum analysis is performed on the cluster region, the result of the spectrum analysis can be displayed on the result screen 13. FIG. 16 is a diagram illustrating an example of the result screen 13 in a case where the spectrum analysis is performed. As illustrated in FIG. 16, for example, in a case where the cluster region is brass made of zinc (Zn) and copper (Cu), the result of the spectrum analysis for the brass is displayed on the result screen 13. The results of the spectral analysis show spectral characteristics of zinc and copper, respectively.

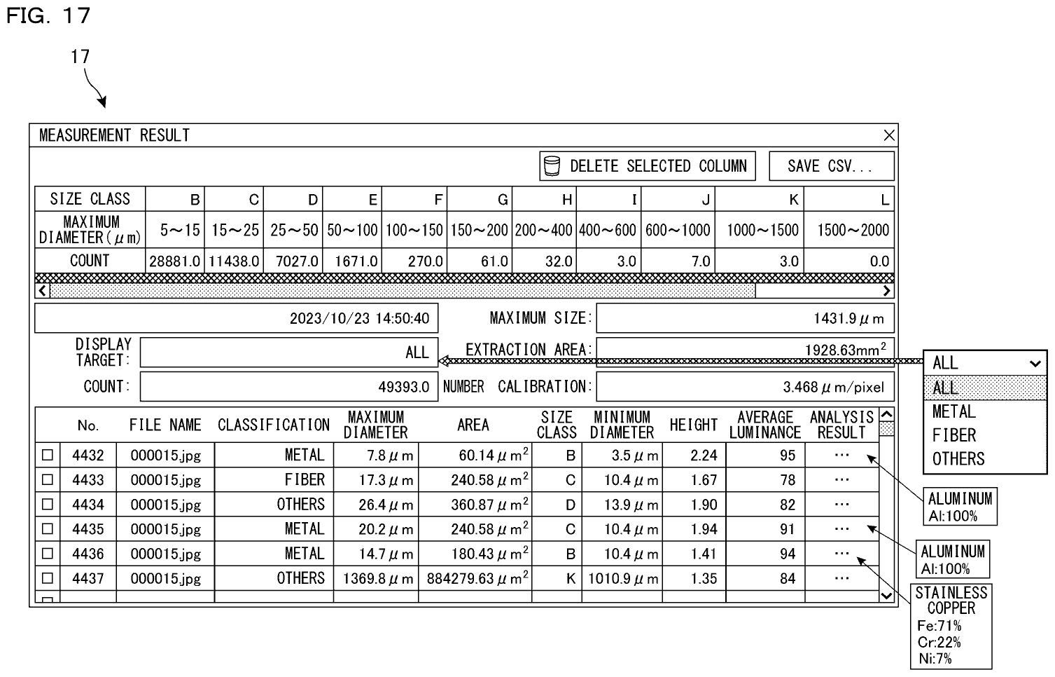

Further, on the result screen 13, as illustrated in an example in FIG. 17, an analysis list 17 listing analysis results of each cluster region may be created by the information processing unit 30 and may be displayed on the display unit 12. In the analysis list 17, a size and a height of each cluster region, classification selected from items such as “metal”, “fiber”, and “others”, component analysis results such as constituent elements and contents thereof, and the like are displayed in a list. Note that, an item field indicating the component analysis result (for example, aluminum, stainless copper, and the like) of the analysis list 17 may be sequentially updated in conjunction with the analysis of the cluster region by the analysis unit 50 and the acquisition of the component analysis result. In addition, in the analysis list 17 of FIG. 17, statistical information such as a maximum size of the cluster region and the number (count) of cluster regions is also displayed in addition to information regarding each cluster region such as the number (No.) assigned to each cluster region, a file name of the observation image or the analysis image including the cluster region (here, it is assumed that all the cluster regions in the list are included in the same image file), and an average luminance of the pixels of each cluster region.

In addition, the information processing unit 30 may update the classification of the cluster region in conjunction with the acquisition of the component analysis result of the cluster region. Specifically, in a case where metal is included in the component analysis result, the cluster region may be determined as “metal”. Note that, the classification result is not limited to the types such as “metal”, “fiber”, and “others”, and a classification item may be added based on a condition defined in advance by the user, for example. Specifically, in a case where Fe, Ni, and Cr are included in the component analysis result of the cluster region, it may be determined as “iron” in accordance with a ratio thereof based on the condition defined by the user in advance. For example, regarding a ratio of the contents of the elements in a case where Fe is included in the cluster region, a threshold as to whether or not to determine “iron” is defined as a condition by the user, and the information processing unit 30 may determine the cluster region as “iron” or “non-iron” in accordance with whether or not the ratio of each element exceeds the threshold. In addition, in the analysis list 17, it may be possible to designate an attribute to be a display target. For example, an input field for setting the display target is provided, and it is preferable that attributes to be the display target such as “all”, “metal”, “fiber”, and “others” can be designated in the input field in a pull-down list. In FIG. 17, since the display target is designated as “all”, the cluster regions of all attributes are displayed.

After the display of the result screen 13, it is determined in step S19 of FIG. 7 whether or not to perform replay. The information processing unit 30 of the observation apparatus 10 can store operating conditions of the observation unit 40, the analysis unit 50, and the unit moving unit 60, and can cause the observation unit 40 and the analysis unit 50 to re-execute the generation of the observation image for the observation target OB and the analysis by the analysis unit 50 under the same conditions as the stored operating conditions.

For example, the operating condition referred to in the replay includes an extraction condition (a luminance threshold, a size range regarded as the cluster region, and the like) for the cluster region specification unit 35 to specify the cluster regions from the observation image. In addition, the operating condition includes an output condition (type of beam, wavelength of beam, output intensity, and the like) of the analysis beam irradiated by the analysis unit 50.

In addition, the operating condition referred to in the replay can include all the contents that can be voluntarily set by the user, such as an illumination condition for the observation target OB by the observation unit 40 and shutter speeds of the observation camera 42 and the analysis camera 52.

In a case where the replay is not executed (NO in step S19), the observation apparatus 10 completes the observation and the analysis, and then waits until the operation of the user is performed. On the other hand, in a case where the replay is executed (YES in step S19), the observation apparatus 10 proceeds to step S20, and the generation of the observation image and the analysis by the analysis unit 50 are executed again according to the stored operating condition.

Note that, at the time of re-execution of observation and analysis by the replay, an observation target OB different from the observation target OB on which first observation and analysis are performed may be mounted on the mounting table 70. Even in a case where the observation target OB mounted on the mounting table 70 is different from the first observation target OB, the observation apparatus 10 can specify cluster regions included in a new observation target OB based on the extraction condition included in the stored operating condition, and can appropriately analyze each cluster region.

What is claimed is:

1. An observation apparatus that observes and analyzes an observation target, the observation apparatus comprising:
a mounting table on which the observation target is mounted;
an observation unit that generates an observation image of the observation target;
an analysis unit that analyzes the observation target; and
an information processing unit that communicates with the observation unit and the analysis unit,
wherein the observation unit includes an observation objective lens that receives light from the observation target, and an observation camera that generates the observation image by capturing the observation target through the observation objective lens,
the analysis unit includes an analysis beam device that emits an analysis beam to the observation target, and a detector that detects energy absorbed by the observation target or energy released from the observation target by irradiation of the analysis beam, and
the information processing unit includes
a capturing control unit that generates the observation image by controlling the observation camera of the observation unit to capture the observation target,
a cluster region specification unit that specifies a plurality of cluster regions included in the observation image,
a sequence determination unit that determines an analysis sequence of analyzing the cluster regions, and
an analysis execution unit that causes the analysis beam device of the analysis unit to sequentially irradiate the cluster regions with the analysis beam according to the analysis sequence determined by the sequence determination unit, and causes the analysis unit to execute analysis of the cluster region based on a detection result of the detector.

2. The observation apparatus according to claim 1, further comprising
a moving unit that changes relative positions of the observation unit and the analysis unit with respect to the mounting table,
wherein, after the observation image is generated by the observation unit, the moving unit changes the relative position of the analysis unit with respect to the mounting table such that a portion of the observation target where the observation image is captured by the observation camera is irradiated with the analysis beam.

3. The observation apparatus according to claim 2, wherein, when the relative position of the analysis unit with respect to the mounting table is changed such that the portion where the observation image is captured is irradiated with the analysis beam, the moving unit calculates a movement amount corresponding to an optical magnification of the observation objective lens of the observation unit when the observation image is generated, and adjusts the relative position of the analysis unit with respect to the mounting table based on the calculated movement amount.

4. The observation apparatus according to claim 2, wherein the moving unit sequentially changes the relative position of the analysis unit with respect to the mounting table according to the analysis sequence determined by the sequence determination unit such that each of the cluster regions is irradiated with the analysis beam.

5. The observation apparatus according to claim 4, wherein
the information processing unit accepts a correction operation of correcting the relative position of the analysis unit with respect to the mounting table such that the relative position of the analysis unit becomes a position corresponding to a predetermined cluster region, and stores a displacement amount corrected by the correction operation, and
the moving unit corrects the relative position of the analysis unit with respect to the mounting table based on the displacement amount stored by the information processing unit when the relative position of the analysis unit with respect to the mounting table is sequentially changed according to the analysis sequence.

6. The observation apparatus according to claim 1, wherein the analysis unit locally plasmatizes the cluster region by the analysis beam, detects light generated from the cluster region by the plasmatization by the detector, and performs analysis based on a spectrum of the light.

7. The observation apparatus according to claim 6, wherein the analysis unit further includes an analysis camera that generates an analysis image by capturing the observation target, and the analysis camera generates the analysis image before the cluster region is irradiated with the analysis beam, generates the analysis image even after the cluster region is irradiated with the analysis beam, and saves a result of the analysis in the cluster region, the analysis image before the irradiation of the analysis beam, and the analysis image after the irradiation of the analysis beam in association with each other.

8. The observation apparatus according to claim 1, wherein the analysis unit emits an electron beam as the analysis beam, and performs analysis based on electrons or characteristic X-rays released from the cluster region with respect to the emission of the electron beam.

9. The observation apparatus according to claim 1, wherein the analysis unit emits X-rays as the analysis beam, and performs analysis based on characteristic X-rays released from the cluster region with respect to the emission of the X-rays.

10. The observation apparatus according to claim 1, wherein the analysis unit performs analysis based on Raman scattered light generated from the cluster region at a wavelength different from a wavelength of incident light emitted as the analysis beam.

11. The observation apparatus according to claim 1, wherein the analysis unit emits infrared light as the analysis beam, and performs analysis based on light transmitted through the cluster region or light reflected by the cluster region.

12. The observation apparatus according to claim 1, wherein the analysis unit emits infrared light as the analysis beam, and performs analysis based on a change in a refractive index of the cluster region due to the emission of the infrared light or analysis based on thermal expansion of the cluster region due to the emission of the infrared light.

13. The observation apparatus according to claim 1, wherein the analysis unit further includes an analysis camera that generates an analysis image by capturing the observation target, and emits the analysis beam in a state where the analysis camera is focused on the cluster region.

14. The observation apparatus according to claim 1, further comprising
a moving unit that changes relative positions of the observation unit and the analysis unit with respect to the mounting table,
wherein the capturing control unit generates a plurality of observation images by causing the observation camera to perform capturing on a plurality of portions of the observation target while changing the relative position of the observation unit with respect to the mounting table by the moving unit, and generates a coupled image obtained by connecting the plurality of observation images, and
the cluster region specification unit specifies the plurality of cluster regions included in the coupled image.

15. The observation apparatus according to claim 1, wherein the cluster region specification unit accepts designation of an extraction condition for specifying the cluster region from the observation image, and specifies, as the cluster region, a region of the observation image matching the extraction condition.

16. The observation apparatus according to claim 1, wherein
the cluster region specification unit specifies a size of each of the plurality of cluster regions, and
the sequence determination unit determines the analysis sequence of a cluster region as an analysis target and the cluster region as the analysis target based on the size of the cluster region.

17. The observation apparatus according to claim 16, further comprising
a Z-direction stage that changes a height of the observation unit with respect to the mounting table,
wherein the capturing control unit generates a plurality of observation images by the observation unit while changing the height of the observation unit by the Z-direction stage,
the information processing unit generates a three-dimensional image of the observation target based on the plurality of observation images generated by the observation unit at different heights with respect to the mounting table,
the cluster region specification unit specifies a height of each of the cluster regions based on the three-dimensional image, and
the sequence determination unit determines the analysis sequence based on a size and a height of the cluster region.

18. The observation apparatus according to claim 1, wherein
the sequence determination unit accepts designation of a priority related to the cluster region, determines the analysis sequence based on the designation of the priority, and divides the analysis sequence into a first sequence and a second sequence executed subsequently to the first sequence,
in the first sequence, the analysis sequence is determined based on the designation of the priority, and
in the second sequence, the analysis sequence related to the cluster region not designated by the designation of the priority is determined.

19. The observation apparatus according to claim 1, wherein
the cluster region specification unit classifies the plurality of cluster regions into two or more attributes, and
the sequence determination unit determines, for each of the cluster regions, an attribute of the cluster region classified by the cluster region specification unit, sets, as an analysis target, a cluster region classified into a predetermined attribute based on a result of the determination, and determines the analysis sequence for the cluster region as the analysis target.

20. The observation apparatus according to claim 1, wherein the information processing unit is capable of storing operating conditions of the observation unit and the analysis unit, and is capable of causing the observation unit and the analysis unit to re-execute the generation of the observation image for the observation target and the analysis by the analysis unit under the same conditions as the stored operating conditions.
